(19) United States
(12) Patent Application Publication
(10) Pub. No.: US 2016/0275535 A1
(43) Pub. Date: Sep. 22, 2016

(54) CENTRALIZED SYSTEM FOR PROGRESSIVE PRICE MANAGEMENT

(71) Applicant: Andrew Bosworth, Palo Alto, CA (US)

(72) Inventor: Andrew Bosworth, Palo Alto, CA (US)

(21) Appl. No.: 14/659,341

(22) Filed: Mar. 16, 2015

(51) Int. Cl. G06Q 30/02

(52) U.S. Cl. CPC G06Q 30/0206

(57) ABSTRACT

A price management system can be configured to manage the sale price for one or more content items. For example, the price management system can maintain content item accounts including data pertaining to the content item, such as the sale price and price calculation rules. The price management system can receive and respond to price queries requesting the price of the content item. The price management system can also update the price of the content items based on the price calculation rules corresponding to the content. For example, the price management system can determine whether a specified trigger or condition has been met and, if so, calculate an updated price for the content item. The price management system can also provide metrics regarding sale of copies of a content item.

### TECHNICAL FIELD

The present technology pertains to price management, and more specifically pertains to a centralized system for progressive price management.

### BACKGROUND

Content creators, such as artists, photographers, etc., make a living selling the content they create. For example, many content creators sell their content in galleries, personal websites and/or through a content retailer website or sales platform. The value of the content is subject to the economic rule of supply and demand dictating that the price increases when demand is higher than the available supply, whereas the opposite is true when the supply is greater than the demand.

One issue that content creators face is consumer uncertainty and/or trust regarding the currently available and/or future supply of the content. For example, many content items, such as photographs, prints, etc., may be easily reproduced by a content creator and sold. As a result, consumers may be skeptical regarding the value of the content because the available supply can be continuously increased, thereby reducing the value of the content.

To address this type of consumer uncertainty, some content creators may offer their content in a limited release resulting in a fixed supply of the content. For example, a photographer may limit the release of one of his/her photographs to only 200 copies. While providing limited releases of a content item provides some clarity regarding current supply of a content item, future supply remains uncertain. For example, a content creator may offer future releases, such as second and third printings of the content item. Further, limiting the release of a content item restricts the content creator's ability to continue to profit from his/her work. As a result, the interests of the content creators and consumer of the content can be directly adverse. Content creators would like to continue to sell more of their content and generate more revenue, while consumers would like the number of content items sold to remain limited, thereby increasing the value of the content they have purchased.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for progressive price management. A price management system can be configured to manage the sale price for one or more content items. For example, the price management system can maintain content item accounts for content items available for sale by content providers. A content item account for a content item can include data pertaining to the content item, such as data regarding available copies of the content item, a price of the content item as well as price calculation rules associated with the content item.

The price management system can receive and respond to price queries requesting the price of the content item. A price query can include a content item identifier identifying the content item and the price management system can use the content item identifier to identify the content item account corresponding to the content item. The price management system can access the price of the content item from the corresponding content item account and provide the price in response to the price query.

The price management system can also update the price of the content items based on the price calculation rules. The price calculation rules corresponding to a content item can be rules and/or conditions agreed to by the content provider that dictate the price at which copies of the content item are to be sold. For example, the price calculation rules can dictate that the price of a content item be updated according to a specified schedule (e.g., after a specified number of copies of the content item have been sold at a set price, at specified time intervals, etc.). After the price has been updated, copies of the content item can then only be purchased for the increased price. As a result, the interests of the content creators and consumers can be aligned because additional purchases of the content items not only generate revenue for the content creators, but also increase the value of the content purchased by previous consumers.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows an exemplary configuration of devices and a network in accordance with the invention;

FIG. 2 shows a method of managing progressive pricing for a content item;

FIG. 3 shows a method of placing a hold on the price of a content item

FIG. 4 shows a method of providing sales metrics for a content item;

FIG. 5 shows a method of updating accounts maintained by the price management system; and

FIGS. 6A and 6B illustrate exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for progressive price management. A price management system can be configured to manage the sale price for one or more content items. A content item can be any type of content created by a content creator that can be reproduced for sale, such as paintings, photographs, prints, sculptures, drawings, posters, music, clothes, books, cards, etc. The price management system can maintain content item accounts for content items available for sale by content providers. A content item account for a content item can include data pertaining to the content item, such as data regarding available copies of the content item, a price of the content item as well as price calculation rules associated with the content item.

The price management system can receive and respond to price queries requesting the price of the content item. A price query can include a content item identifier identifying the content item and the price management system can use the content item identifier to identify the content item account corresponding to the content item. The price management system can access the price of the content item from the corresponding content item account and provide the price in response to the price query.

The price management system can also update the price of the content items based on the price calculation rules. The price calculation rules corresponding to a content item can be rules and/or conditions agreed to by the content provider that dictate the price at which copies of the content item are to be sold. For example, the price calculation rules can dictate that the price of a content item be updated according to a specified schedule (e.g., after a specified number of copies of the content item have been sold at a set price, at specified time intervals, etc.). After the price has been updated, copies of the content item can then only be purchased for the increased price. As a result, the interests of the content creators and consumers can be aligned because additional purchases of the content items not only generate revenue for the content creators, but also increase the value of the content purchased by the previous consumers.

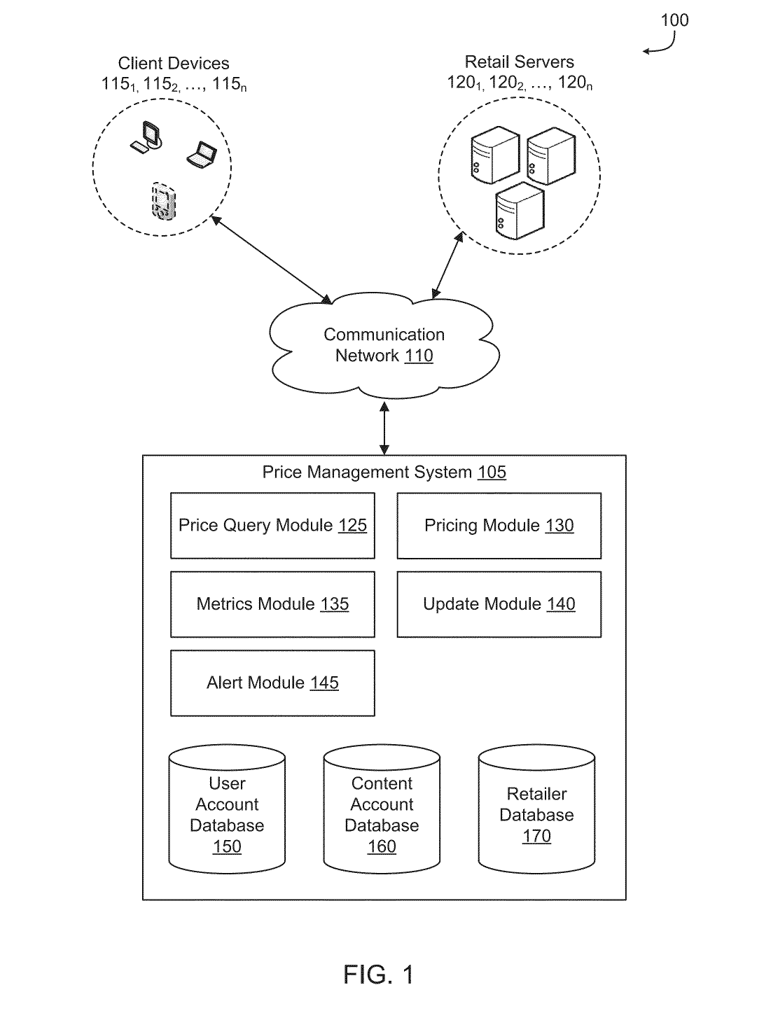

FIG. 1 illustrates an exemplary system configuration 100, wherein electronic devices communicate via a network for purposes of exchanging content and other data. As illustrated, multiple computing devices can be connected to communication network 110 and be configured to communicate with each other through use of communication network 110. Communication network 110 can be any type of network, including a local area network (“LAN”), such as an intranet, a wide area network (“WAN”), such as the internet, or any combination thereof. Further, communication network 110 can be a public network, a private network, or a combination thereof. Communication network 110 can also be implemented using any number of communication links associated with one or more service providers, including one or more wired communication links, one or more wireless communication links, or any combination thereof. Additionally, communication network 110 can be configured to support the transmission of data formatted using any number of protocols.

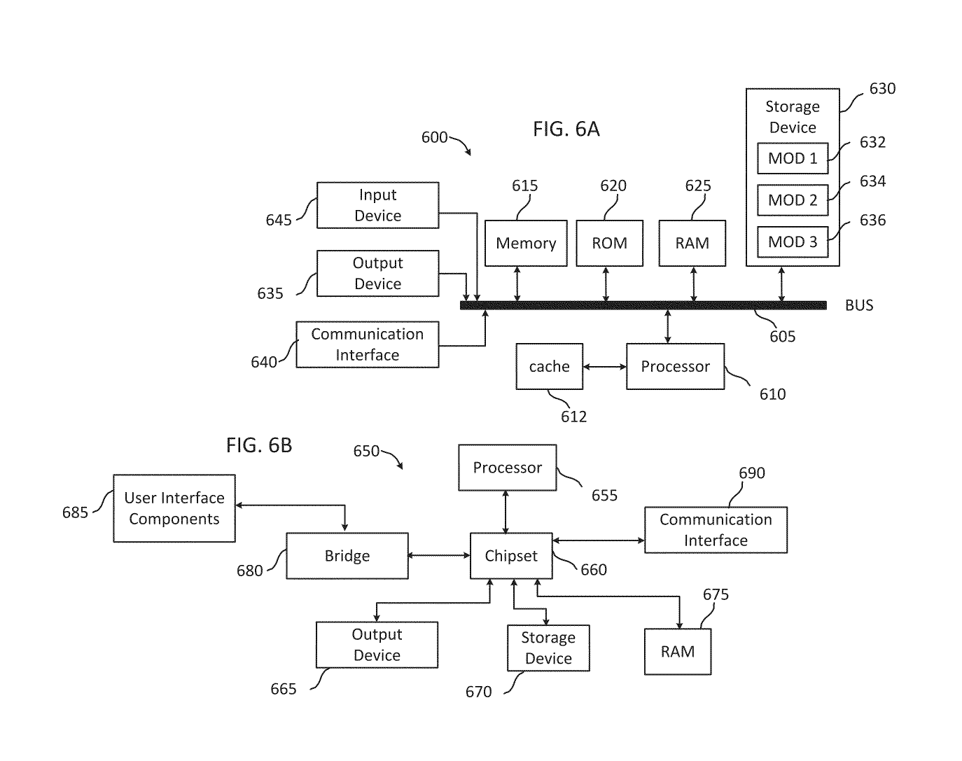

Multiple computing devices can be connected to communication network 110. A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 600 of FIGS. 6A and 6B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

As shown, price management system 105, retail servers 120₁, 120₂, . . . , 120ₙ (collectively “120”) and client devices 115₁, 115₂, . . . , 115ₙ (collectively “115”) can be connected to communication network 110 to communicate with each other. A retail server 120ᵢ can be one or more computing devices configured to provide an online content store where users can browse and purchase content items available for sale.

Price management system 105 can be a computing system comprising of one or more computing devices configured to manage prices for content items. Price management system 105 can receive price queries from retail servers 120 and/or client devices 115. A price query can be a request for the price of a specified content item. In response to a price query, price management system 105 can transmit the price of the specified content item to the requesting retail server 120ᵢ and/or client device 115ᵢ.

Users can interact with price management system 105 and/or retail servers 120 through use of client devices 115. Price management system 105 and retail servers 120 can support connections from a variety of different types of client devices 115, such as desktop computers; mobile computers; mobile communications devices (e.g. mobile phones, smart phones, tablets, etc.); smart televisions; set-top boxes; point of sale (POS) devices, and/or any other network enabled computing devices. Client devices 115 can be of varying type, capabilities, operating systems, etc. Furthermore, price management system 105 and retail servers 120 can concurrently accept connections from and interact with multiple client devices 115.

A user can interact with price management system 105 and retail servers 120 using client-side applications installed on client device 115ᵢ. In some embodiments, a client-side application can include a price management system and/or retail server specific component. For example, the component can be a stand-alone application, one or more application plug-ins, and/or a browser extension. However, the user can also interact with price management system 105 and/or retail servers 120 using a third-party application, such as a web browser, that resides on client device 115ᵢ and is configured to communicate with other computing devices in network communication with client device 115ᵢ (e.g., content management system 105 and/or retail servers 120). In either case, the client-side application can present a user interface (UI) for the user to interact with price management system 105 and/or retail servers 120. For example, the user can interact with price management system 105 and/or retail servers 120 using a client-side application integrated with the file system or via a webpage displayed using a web browser application.

Price management system 105 can manage the price for multiple content items. For example, price management system 105 can include price query module 125 configured to receive price queries from client devices 115 and/or retail servers 120. A price query can be a request for the price of a specified content item. A price query can be received as a result of a user using one of client devices 115 to communicate with price management module 105 to request the price of a specified content item.

Alternatively, a price query can be received from one of retail servers 120 as a result of a user using one of client devices 115 to communicate with retail server 120ᵢ to request the price of a content item. Retail servers 120 may provide a user interface and user interface elements enabling users to browse content items available for purchase and/or request the price of any of the content items, resulting in the retail server 120ᵢ transmitting a price query to price management system 105. For example, the retail server 120ᵢ may provide a user interface element enabling a user to request the price of a content item. Alternatively, the retail server 120ᵢ may be configured to transmit a price query when a user navigates to a webpage listing a specified content item for sale. The returned sales price can then be presented within the webpage listing for the specified content item.

A price query can include metadata identifying the specified content item. For example, a price query can include a content item identifier that uniquely identifies the content item for which a price is requested. In response to receiving a price query, price query module 125 can identify the price of the specified content item. For example, price management system 105 can include content account database 160 configured to maintain content item accounts for content items. Each content item account can correspond to a content item and include metadata regarding the content item, such as a sales price for the content item, number of copies of the content item that have been sold, remaining inventory of the content item, times at which copies of the content item were sold, retailers that sold the content item, retailers that sell the content item, consumers that have purchased the content item, etc. Further, each content item account can be tagged, labeled and/or otherwise identified by the content item identifier corresponding to the content item. Price query module 125 can communicate with content account database 160 to identify the content item account corresponding to the content identifier received in the price query.

Price query module 125 can gather the purchase price from the content item account and return the requested price in response to the price query. For example, price query module 125 can transmit the price to the requesting client device 115ᵢ and/or content retail server 120ᵢ from which the price query was received.

Price management system 105 can also provide progressive pricing for content items. Progressive pricing can be increasing and/or calculating an updated price for a content item according to a specified schedule and/or conditions. For example, price management system 105 can include pricing module 130 configured to calculate an updated price for a content item according to a set of price calculation rules associated with the content item. The price calculation rules can identify a set of triggers, conditions, etc., that, when met, result in calculation of an updated price of a content item. The price calculation rules can also identify a set of formulas, functions, variables, etc., used to calculate the updated price of the content item.

The price calculation rules associated with a content item can be based on conditions agreed to by a content creator of the content item. For example, a content creator can agree that copies of a content item will be priced and sold according to the price calculation rules. As a result, consumers can purchase copies of the content item with confidence that future copies of the content item will be sold according to the agreed price calculation rules.

In some embodiments, the price calculation rules associated with a content item can be stored in content account database 160 and associated with the corresponding content item account. Pricing module 130 can communicate with content account database 160 to retrieve the price calculation rules associated with a content item. For example, pricing module 130 can use a content item identifier identifying a content item to access the content item account corresponding to the content item from content account database 160 and retrieve the price calculation rules for the content item.

Pricing module 130 can calculate updated prices for content items based on the price calculation rules for the content item. The price calculation rules can identify a set of one or more conditions and/or triggers that, when met, result in the price of the content item being updated. For example, the price calculation rules can dictate that the price of a content item be updated when specified time triggers are met, such as a specified number of days, months, years, etc., elapsing from the initial sale of the content item and/or sale of a previous copy of the content item. As another example, the price calculation rules can dictate that the price of a content item be updated when a specified number of copies of the content item have been sold, such as after every 1, 2, 3, 4, etc., copies of the content item being sold.

Pricing module 130 can retrieve the price calculation rules for the content item and determine whether one of the triggers or condition specified by the price calculation rules has been met. For example, pricing module 130 can gather a current time value to determine whether a time based trigger or condition has been met. As another example, pricing module 130 can retrieve the number of copies of the content item that have been sold from the content item account for the content item. Pricing module 130 can then determine whether a trigger or condition has been met based on the number of copies of the content item that have been sold. If pricing module 130 determines that a condition or trigger has been met, pricing module 130 can calculate an updated price for the content item.

In some embodiments, pricing module 130 can periodically check whether a condition or trigger has been met. For example, pricing module 130 can be configured to access the price calculation rules for a content item based on a specified schedule and determine whether a trigger or condition has been met.

As another example, pricing module 130 can be configured to determine whether a condition or trigger has been met when a price query for the content item is received. Pricing module 130 can determine whether a condition or trigger has been met and, if so, calculate an updated price for the content item prior to the sale price being returned in response to the price query. Determining whether a condition or trigger has been met each time a price query for a content item has been received can ensure that the sale price returned in response to the price query is always the updated or most recent sale price.

As another example, pricing module 130 can be configured to determine whether a condition or trigger has been met after each copy of the content item has been purchased. Price management system 105 can be configured to receive confirmation messages indicating that a copy of the content item has been purchased. For example, price management system 105 can receive a confirmation message from any of retail servers 120 and/or client devices 115. In response to receiving a confirmation message that a content item has been purchased, pricing module 130 can determine whether a condition or trigger has been met that would result in updating the sale price of the content item.

If pricing module 130 determines that a trigger or condition for a content item has been met, pricing module 130 can calculate an updated sales price for the content item based on the price calculation rules. Pricing module 130 then update the content item account associated with the content item to reflect the updated price. As a result, the updated price will be returned in response to future price queries for the price of the content item.

In some embodiments, the price calculation rules can identify a single algorithm, function, etc., for updating the sale price of a content item. Thus, each time a trigger or condition associated with the content item is met, pricing module 130 will use the same algorithm, function, etc., to calculate the updated sale price for the content item.

In some embodiments, the price calculation rules can identify multiple algorithms, functions, etc., for updating the price of the content item. For example, the price calculation rules can identify an algorithm, function, etc., corresponding to each trigger or condition associated with the content item. Thus, when a specified trigger or condition is met, pricing module 130 will calculate an updated price based on the algorithm, function, etc., corresponding to the specific trigger or condition.

In some embodiments, pricing module 130 can calculate the updated sales price based on the current sale price of the content item. For example, the updated sale price can be calculated by incrementing the sale price by a set monetary amount (e.g., $10) or a set percentage of the sale price (e.g., 10%).

In some embodiments, pricing module 130 can calculate the updated sale price based on an amount of time that has elapsed between sales of copies of the content item. For example, the price calculation rules can include a formula whereby the amount by which the sale price of the content item is increased is converse to the time amount of elapsed between sales of copies of the content item. The resulting updated sales price will therefore be higher when the time elapsed between sales of copies of the content item is shorter and vice versa.

Pricing module 130 can gather the times at which copies of the content item have been sold from the corresponding content item account and determine the time between sales of the content item based on the gathered times. In some embodiments, the time between sales of the content item can be based on the time at which the previous two purchases of the content item occurred. Alternatively, the time between sales of the content item can be an average time between sales of the content item.

In some embodiments, pricing module 130 can calculate the updated sales price based on a determined velocity at which copies of the content item are being sold. Pricing module 130 can determine the number of copies of a content item sold within a predetermined time period and then determine the velocity at which copies of the content item are being sold during the predetermined time period. The updated price of a content item can be calculated based on the determined velocity such that the greater the velocity, the greater the increase in the price of the content item, and vice versa.

In some embodiments, pricing module 130 can calculate the updated sales price based on a determined rate of acceleration of sales of the content item. For example, pricing module 130 can compare the determined velocity of the content item over multiple time periods to determine an acceleration rate at which purchases of the content are being made. The updated price of the content item can be calculated based on the determined acceleration rate such that the greater the acceleration rate, the greater the increase in the price of the content item, and vice versa.

In some embodiments, pricing module 130 can calculate an updated sales price of a content item based on a remaining number of content items available in inventory. For example, the updated price for a content item can be calculated such that the lower the number of copies of the content item remaining in inventory, the greater the increase in the price of the content item, and vice versa.

In some embodiments, the price calculation rules can dictate that the price of a content item can only increase. For example, a content creator may agree to never reduce the sale price of a content item to ensure consumers that the content item will not reduce in value. Alternatively, a content creator may agree to only reduce the price of a content item if specified conditions are met. As a result, in some embodiments, the price calculation rules can dictate that the price of a content item can increase or decrease based on one or more factors.

In addition to updating the sale price of a content item, price management system 105 can also transmit an alert message that the price of the content item has been changed. For example, price management system 105 can include alert module 145 that is configured to transmit an alert message to any of retail server 120 and/or client devices 115. An alert message can indicate that the price of the content item has changed and that the content item can no longer be purchased at the previous price. The alert message can also include the updated price of the content item. The retail servers 120 and/or client devices 115 that received an alert message can then present the user with a notification that the price of the content item has been updated and any previously presented price is no longer valid.

In some embodiments, alert module 145 can transmit the alert message to each client device 115 and/or retail server 120 that has transmitted a price query for the content item to price management system 105. Price query module 125 can maintain a price query index for each content item. A price query index can list each client device 115 and/or retail server 120 that has transmitted a price query for the content item to price management system 105. The pricing index for each content item can be stored in content account database 160 and associated with the corresponding content item account. Price query module 125 can update the appropriate price query index as each price query is received.

Alert module 145 can use the price query index to identify client devices 115 and/or retail servers 120 that have transmitted a price query for the content item. Alert module 145 can then transmit an alert message to the identified client devices 115 and/or retail servers 120.

In some embodiments, alert module 145 can transmit an alert message to each client device 115 and/or retail server listed in the price query index. Alternatively, alert module 145 can transmit an alert message to a subset of the client devices 115 and/or retail servers 120 listed in the price query index. For example, alert module 145 can transmit an alert message to client devices 115 and/or retail servers 120 that transmitted a price query within a specified time period, such as within the previous 10 minutes, 20 minutes, etc. Alternatively, in some embodiments, alert module 145 can transmit an alert message to client devices 115 and/or retail servers 120 that have an active session with price management system 105.

Transmitting alert messages when the price of a content item has been updated can ensure that the content item is not sold for an incorrect price. To further this goal, in some embodiments, price management system 105 can require that a price query be transmitted prior to completing a purchase for the content item. For example, retail servers 120 and/or client devices 115 can transmit a price query to price management system 105 at a moment when the purchase of the content item appears to be imminent. For example, a retail server 120ᵢ can transmit a price query when a user enters the content item in their shopping cart, provides payment information, is prompted to confirm the purchase, and/or at another moment indicating that the content item is likely to be purchased. Likewise, a client device 115ᵢ such as a POS device can transmit a price query when the content item is selected or scanned for purchase, payment information is received, etc.

Further, in some embodiments, price management system 105 can be configured to hold or reserve a price of the content item for a specified period of time after receiving an indication that a purchase for the content item is imminent. For example, a price query can be flagged to indicate that a purchase is imminent. For example, retail servers 120 can flag a price query when the price query is sent in response to a user adding the content item to a shopping cart or other moment indicating that the user intends to purchase the content item. Likewise, a client device 115ᵢ, such as a POS device, can flag a price query when a user is attempting to purchase the content item.

Alternatively, an indication that a purchase of a content item is imminent can be received separately from a price query. For example, client devices 115 and/or retail servers 120 can be configured to transmit a message to price management system 105 indicating that a purchase of the content item is imminent. Client devices 115 and/or retail servers 120 can send the indication as a result of one or more specified triggers occurring that indicate that a sale of the content item in imminent, such as when a user enters the content item in their shopping cart, provides payment information, is prompted to confirm the purchase, and/or at another moment indicating that the content item is likely to be purchased.

In response to receiving a price query that has been flagged, price query module 125 can hold or reserve the current price for a predetermined amount of time, during which other price queries for the content item can be denied, queued and/or result in an error message that the sale price has been placed on hold. If a confirmation message that the purchase has been completed has not been received within the predetermined time, price query module 125 can remove the hold and begin to again respond to price queries. For example, price query module 125 can first respond to any queued price queries that were received while the price of the content item was on hold. Alternatively, if a confirmation message is received indicating that the purchase has been completed, price query module 125 can determine whether the price of the content item needs to be updated and, if so, calculate the updated price.

In addition to managing progressive pricing for content items, price management system 105 can also provide consumers and/or other users with sales metrics regarding the content items. For example, price management system 105 can include metrics module 135 configured to provide sales metrics for a specified content item.

Metrics module 135 can be configured to receive a metrics request from a client device 115ᵢ and/or retail server 120ᵢ. A metrics request can be a request for sales metrics for a specified content item. For example, a metrics request can include a content item identifier identifying the specified content item as well as metadata identifying the requested sales metrics. In response to receiving a metrics request, metrics module 135 can access the corresponding content item account in content account database 160 and retrieve and/or calculate the requested sales metrics.

Metrics module 135 can provide the requested metrics to the requesting client device 115ᵢ and/or the requesting retail server 120ᵢ. For example, the requested metrics can be presented in a metrics interface that enables a user to view the requested metrics and/or manipulate the metrics to filter and/or rearrange the order of the data as well as present the data in various graphs, charts, etc.

Metrics module 135 can be configured to provide a variety of different sales metrics for a content item. For example, metrics module 135 can provide the number of copies of the content item that have been sold, the date and time the copies were sold, the prices at which the content items were sold, the time between sales, the velocity at which the content item were sold, the rate of acceleration at which the content item are sold, retailers from which the content item were purchased, remaining inventory, etc.

Additionally, metrics module 135 can also provide details regarding retailers that have sold copies of the content item and/or consumers that have purchased the content item. For example, price management system 105 can include user account database 150 and retailer database 170 configured to maintain user accounts and retailer accounts respectively. A user account can include data regarding users that have purchased copies of the content item. For example, a user account can include data such as the user's name, address, etc.

Likewise, a retailer account can include data regarding retailers that sell and/or have sold copies of a content item. For example, a retailer account can include the name, location, number of copies sold, number of copies available, etc., for the retailer.

Metrics module 135 can be configured to communicate with user account database 150 and retailer database 170 to access user and retailer accounts associated with a content item (e.g., user accounts corresponding to users that have purchased the content item and/or retailer accounts corresponding to retailers that sell and/or have sold the content item). Metrics module 135 can present data gathered from the retailer and user accounts as part of the sales metrics. For example, the metrics module 135 can provide the location of consumers that purchased the content items, the retailers that purchased the content item, the location of the retailers that purchased the content item, etc.

Price management system 105 can also include update module 140 configured to update data regarding a content item, retailer and/or user. For example, update module 140 can be configured to receive update messages from client devices 115 and retail server 120. An update message can be any type of message indicating that data maintained by price management system 105 should be updated. For example, an update message can be an authorization message indicating that a transaction to purchase a copy of a content item has been completed. As another example, an update message can be a message provided by a retailer indicating updated information for the retailer.

An update message can include metadata describing the update, such as a time a content item was purchased, the purchasing user, the retailer that sold the content item, updated contact information, etc. In response to receiving an update message, update module 140 can access any of user account database 150, content account database 160 and/or retailer database 170 and update them accordingly.

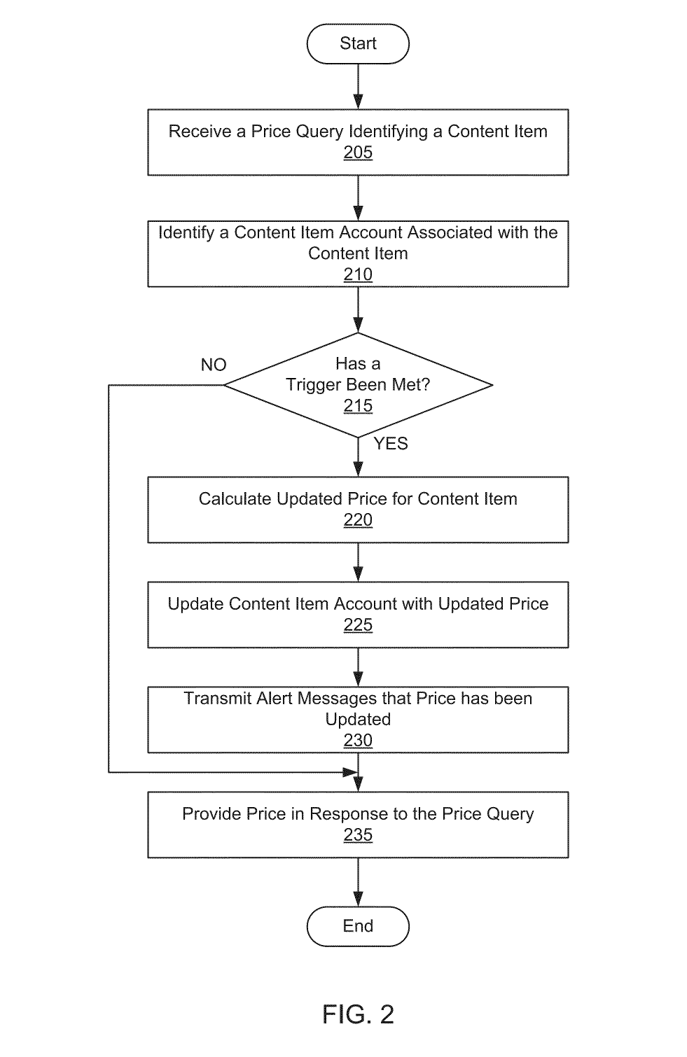

FIG. 2 shows a method of managing progressive pricing for a content item. The method shown in FIG. 2 is described in view of the system shown in FIG. 1. Although specific steps are shown in FIG. 2, in other embodiments the method may have more or less steps. Further, the order in which the steps are performed is just one possible embodiment and is not meant to be limiting. The method may be performed in a variety of differing orders, including one or more steps being performed simultaneously, and/or including more or less steps than those shown in FIG. 2.

As shown, the method begins at block 205 where price management system 105 receives a price query. A price query can be a request for the price of a content item. For example, a price query can be received from a client device 115ᵢ as a result of a human user of the client device 115ᵢ requesting the price of the content item.

Alternatively, the price query can be received from a retail server 120ᵢ. For example, a user can use a client device 115ᵢ to communicate with the retail server 120ᵢ and access a retail interface provided by the retail server 120ᵢ. The retail interface can allows the user to browse content items available for purchase. The retail server 120ᵢ can transmit the price query to price management system 105 in response to the user navigating to a webpage presenting a content item or the user selecting a user interface element to request the price of the content item.

The price query can include a content item identifier identifying the specified content item for which the price is being requested. At block 210, price management system 105 can identify the content item account associated with the content item. For example, price query module 125 can use the content item identifier included in the price query to search content account database 160 for the corresponding content item account. The content item account can include data pertaining to the content item, such as the price of the content item as well as price calculation rules associated with the content item.

At block 215, pricing module 130 can determine whether a trigger or condition has been met. For example, the price calculation rules corresponding to the content item can identify a set of one or more triggers or conditions that, if met, indicate that the price of the content item should be calculated. Based on the price calculation rules, pricing module 130 can determine whether a trigger or condition has been met.

For example, in some embodiments, the trigger or condition can be based on the number of copies of the content item that have been sold. Pricing module 130 can compare the number of content items that have been sold to a threshold numbers of content items dictated by the price calculation rules to determine whether the condition or trigger has been met. If the number of copies of the content item that have been sold meets or exceeds the threshold number, pricing module 130 can determine that the condition or trigger has been met.

In some embodiments, the trigger or condition can be based on time. Pricing module 130 can compare a current time value to a threshold time value dictated by the price calculation rules to determine whether the condition or trigger has been met. If the current time value meets or exceeds the threshold time value, pricing module 130 can determine that the condition or trigger has been met.

If at block 215, pricing module 130 determines that the trigger or condition has not been met, the method continues to block 235 where price query module 125 can provide the price of the content item in response to the price query. For example, price query module 125 can transmit a message including the price of the content item to the requesting client device 115ᵢ and/or requesting retail server 120ᵢ from which the price query was received.

Alternatively, if at block 215, pricing module 130 determines that the trigger or condition has been met, the method can continue to block 220 where pricing module 130 can calculate an updated price for the content item. For example, pricing module 130 can calculate an updated price based on the price calculation rules corresponding to the content item

At block 225, pricing module 130 can update the content item account with the updated price that was calculated. This can include pricing module 130 adding the updated price to the content item account and designating the updated price as the current price of the content item. Alternatively, pricing module 130 can replace the previous sales price with the updated sales price.

At block 230, alert module 145 can transmit an alert message to one or more of client devices 115 and/or retail servers 120. The alert message can notify client devices 115 and/or retail servers 120 that the price of the content item has been updated and any previously received price is no longer valid. The alert message can further include the updated price.

At block 235, price query module 125 can provide the updated price in response to the price query.

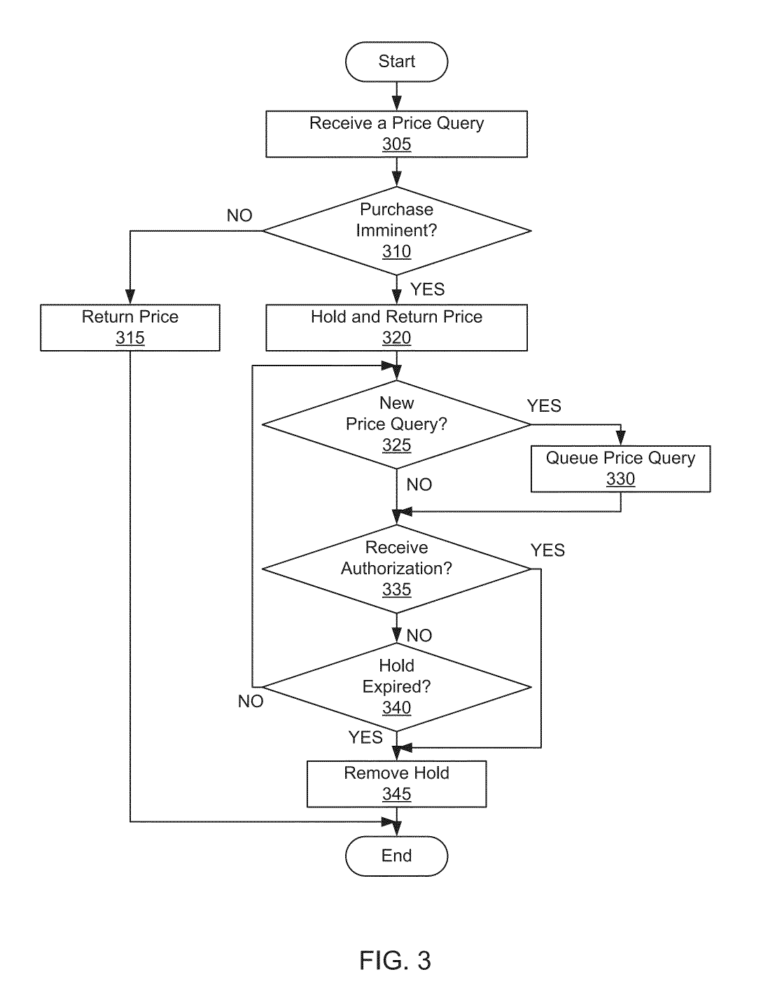

FIG. 3 shows a method of placing a hold on the price of a content item. The method shown in FIG. 3 is described in view of the system shown in FIG. 1. Although specific steps are shown in FIG. 3, in other embodiments the method may have more or less steps. Further, the order in which the steps are performed is just one possible embodiment and is not meant to be limiting. The method may be performed in a variety of differing orders, including one or more steps being performed simultaneously, and/or including more or less steps than those shown in FIG. 3.

As shown, the method begins at block 305 where price query module 125 receives a price query for the price of a content item.

At block 310, price query module 125 determines whether a purchase of the content item is imminent. For example, price query module 125 can check whether the price query has been flagged or otherwise tagged to indicate that a purchase of the content item is imminent. If at block 310, price query module 125 determines that a purchase is not imminent, the method continues to block 315 where price query module 125 returns the price of the content item in response to the price query. This can include pricing module 130 determining whether the price needs to be updated, calculating an updated price, as well as alert module 145 transmitting alert messages, if necessary.

Alternatively, if at block 310, price query module 125 determines that a purchase of the content item is imminent, the method continues to block 320 where price query module 125 places a hold on the price of the content item and returns the price in response to price query. This can also include pricing module 130 determining whether the price needs to be updated and calculating an updated price, as well as alert module 145 transmitting alert messages, if necessary.

At step 325, if price query module 125 receives new price queries for the content item while a hold has been placed on the price of the content item, the method can continue to block 330 where price query module 125 can queue the new price queries that have been received. Queued price queries can be processed in the order in which they were received after the hold on the content item has been removed.

At step 335, if price management system 105 receives an authorization message indicating the content item has been purchased, the method can continue to block 345 where price query module 125 can remove the hold placed on the content item and begin processing price queries for the content item. Further, pricing module 130 can determine whether the price of the content item needs to be updated and calculate an updated price, as well as alert module 145 transmitting alert messages, if necessary.

At step 340, price query module 125 can determine whether the hold on the content item has expired. For example, a hold placed on the price of a content item can be scheduled to expire after a predetermined amount of time has elapsed since the hold was placed. If at block 340, price query module 125 determines that the predetermined amount of time has elapsed, the method can continue to block 345 where price query module 125 can remove the hold placed on the content item and begin processing price queries for the content item. Further, pricing module 130 can determine whether the price of the content item needs to be updated and calculate an updated price, as well as alert module 145 transmitting alert messages, if necessary.

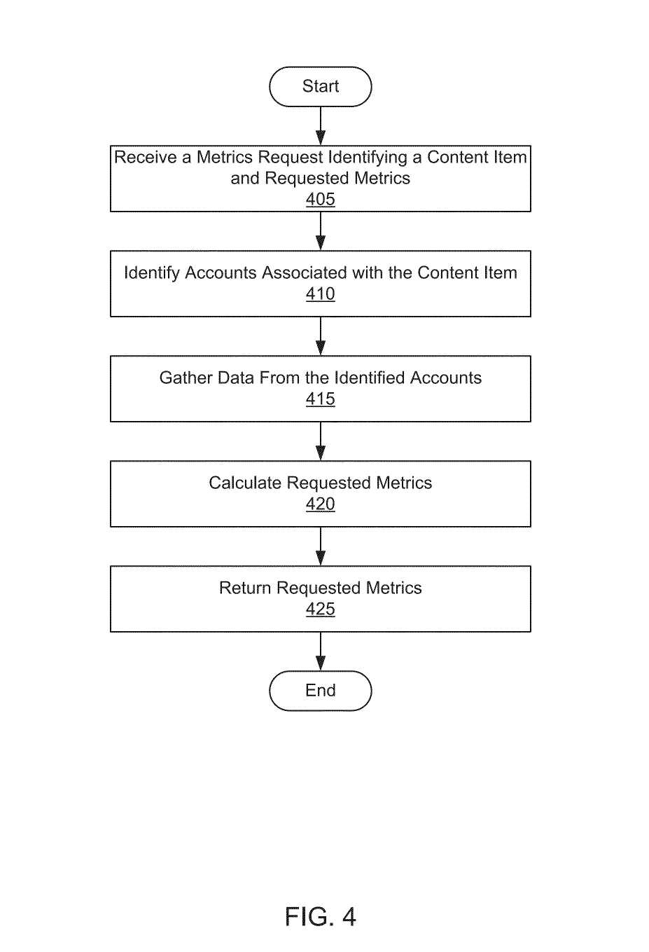

FIG. 4 shows a method of providing sales metrics for a content item. The method shown in FIG. 4 is described in view of the system shown in FIG. 1. Although specific steps are shown in FIG. 4, in other embodiments the method may have more or less steps. Further, the order in which the steps are performed is just one possible embodiment and is not meant to be limiting. The method may be performed in a variety of differing orders, including one or more steps being performed simultaneously, and/or including more or less steps than those shown in FIG. 4.

As shown, the method begins at block 405 where price management system 105 receives a metrics request identifying a content item and requested metrics. For example, the metrics request can be received from one of client devices 115 and/or retail servers 120 and can include a content item identifier identifying a content item.

At block 410, metrics module 135 can identify accounts associated with the content item. For example, metrics module 135 can communicate with any of user account database 150, content account database 160 and/or retailer database 170 to identify the content item account corresponding to the content item, retailer accounts that sell and/or have sold the content item and user accounts for users that have purchased the content item.

At block 415, metrics module 135 can gather data from the identified accounts that were requested by the metrics request and/or needed to calculate the requested metrics.

At block 420, metrics module 135 can calculate the requested metrics. For example, metrics module 135 can use the data gathered from the identified accounts to calculate any requested metrics.

At block 425, metrics module 135 can return the requested metrics in response to the metrics request. For example, metrics module 135 can transmit the requested metrics to the client device 115ᵢ and/or retail server 120ᵢ from which the metrics request was received. The returned metrics can then be presented in a metrics interface where a user can view and/or manipulate the requested metrics.

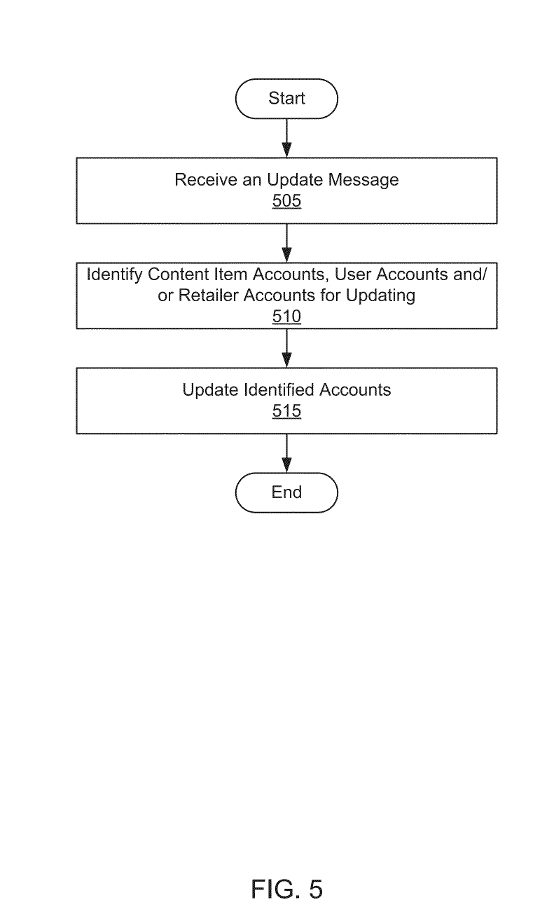

FIG. 5 shows a method of updating accounts maintained by the price management system. The method shown in FIG. 5 is described in view of the system shown in FIG. 1. Although specific steps are shown in FIG. 5, in other embodiments the method may have more or less steps. Further, the order in which the steps are performed is just one possible embodiment and is not meant to be limiting. The method may be performed in a variety of differing orders, including one or more steps being performed simultaneously, and/or including more or less steps than those shown in FIG. 5.

As shown, the method begins at block 505 where price management system 105 receives an update message. An update message can be any type of message indicating that an account maintained by price management system 105 should be updated. For example, an update message can be an authorization message indicating that a transaction for the sale of a content item has been completed. An update message can be received from a client device 115ᵢ and/or a retail server 120ᵢ.

At block 510, update module 140 can identify content item accounts, user account and/or retailer accounts for updating. For example, if the update request is an authorization request indicating that a transaction for purchase of a content item has been completed, update module 140 can identify the content item account, retailer account and user accounts corresponding to the purchase.

At block 515, update module 140 can update the identified accounts. For example, update module 140 can alter data in the identified accounts to reflect the change, completed transaction, etc.

FIG. 6A, and FIG. 6B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving, by a computer processor, a first price query for a current price of a content item, the first price query including a content item identifier identifying the content item;
identifying, by the computer processor, based on the content item identifier, a content item account associated with the content item, the content item account including price calculation rules for the content item and a first monetary value designated as the current price of the content item, the price calculation rules identifying a set of price calculation conditions for updating the current price of the content item, and the price calculation rules identifying a set of algorithms for updating the current price of the content item;
determining, by the computer processor, based on the set of price calculation rules, that a first price calculation condition of the set of price calculation conditions has been met;
calculating, by the computer processor, based on at least a first algorithm of the set of algorithms, a second monetary value;
designating, by the computer processor, the second monetary value as the current price of the content item, yielding a first updated content item account; and
returning, by the computer processor, the second monetary value in response to the first price query.

2. The method of claim 1, further comprising:
receiving a second price query for the current price of the content item, the second price query including the content item identifier;
identifying, based on the content item identifier, the first updated content item account;
determining that none of the set of price calculation conditions have been met;
returning the second monetary value in response to the second price query.

3. The method of claim 1, wherein determining that the first price calculation condition of the set of price calculation conditions has been met comprises:
determining that a number of copies of the content item that have been sold meets or exceed a threshold number dictated by the first price calculation condition.

4. The method of claim 1, wherein determining that the first price calculation of the set of price calculation conditions has been met comprises:
determining that a current time value meets or exceeds a threshold time value dictated by the first price calculation condition.

5. The method of claim 1, wherein calculating the second monetary value comprises multiplying the first monetary value by a predetermined multiplier, yielding the second monetary value.

6. The method of claim 1, wherein calculating the second monetary value comprises:
determining a velocity at which copies of the content item have been sold over a predetermined time period, wherein the second monetary value is calculated based on at least the velocity.

7. The method of claim 1, further comprising:
receiving a second price query for the current price of a content item, the second price query including the content item identifier identifying the content item;
identifying the first updated content item account associated with the content item identifier;
determining, based on the set of price calculation rules, that a second price calculation condition of the set of price calculation conditions has been met;
calculating, based on at least a second algorithm of the set of algorithms, a third monetary value;
designating the third monetary value as the current price of the content item, yielding a second updated content item account; and
returning the third monetary value in response to the second price query.

8. A system comprising:
a computer processor; and
a memory containing instructions that, when executed, cause the computer processor to:
receive a first price query for a current price of a content item, the first price query including a content item identifier identifying the content item;
identify, based on the content item identifier, a content item account associated with the content item, the content item account including price calculation rules for the content item and a first monetary value designated as the current price of the content item, the price calculation rules identifying a set of price calculation conditions for updating the current price of the content item, and the price calculation rules identifying a set of algorithms for updating the current price of the content item;
determine, based on the set of price calculation rules, that a first price calculation condition of the set of price calculation conditions has been met;
calculate, based on at least a first algorithm of the set of algorithms, a second monetary value;
designate the second monetary value as the current price of the content item, yielding a first updated content item account; and
return the second monetary value in response to the first price query.

9. The system of claim 8, wherein the instructions further cause the computer processor to:
receive a second price query for the current price of the content item, the second price query including the content item identifier;
identify, based on the content item identifier, the first updated content item account;
determine that none of the set of price calculation conditions have been met;
return the second monetary value in response to the second price query.

10. The system of claim 8, wherein determining that the first price calculation condition of the set of price calculation conditions has been met comprises:
determining that a number of copies of the content item that have been sold meets or exceed a threshold number dictated by the first price calculation condition.

11. The system of claim 8, wherein determining that the first price calculation of the set of price calculation conditions has been met comprises:
determining that a current time value meets or exceeds a threshold time value dictated by the first price calculation condition.

12. The system of claim 8, wherein calculating the second monetary value comprises multiplying the first monetary value by a predetermined multiplier, yielding the second monetary value.

13. The system of claim 8, wherein calculating the second monetary value comprises:
determining a velocity at which copies of the content item have been sold over a predetermined time period, wherein the second monetary value is calculated based on at least the velocity.

14. The system of claim 8, wherein the instructions further cause the computer processor to:
receive a second price query for the current price of a content item, the second price query including the content item identifier identifying the content item;
identify the first updated content item account associated with the content item identifier;
determine, based on the set of price calculation rules, that a second price calculation condition of the set of price calculation conditions has been met;
calculate, based on at least a second algorithm of the set of algorithms, a third monetary value;
designate the third monetary value as the current price of the content item, yielding a second updated content item account; and
return the third monetary value in response to the second price query.

15. A non-transitory computer-readable medium containing instructions that, when executed by a computer processor, cause the computer processor to:
receive a first price query for a current price of a content item, the first price query including a content item identifier identifying the content item;
identify, based on the content item identifier, a content item account associated with the content item, the content item account including price calculation rules for the content item and a first monetary value designated as the current price of the content item, the price calculation rules identifying a set of price calculation conditions for updating the current price of the content item, and the price calculation rules identifying a set of algorithms for updating the current price of the content item;
determine, based on the set of price calculation rules, that a first price calculation condition of the set of price calculation conditions has been met;
calculate, based on at least a first algorithm of the set of algorithms, a second monetary value;
designate the second monetary value as the current price of the content item, yielding a first updated content item account; and
return the second monetary value in response to the first price query.

16. The non-transitory computer-readable medium of claim 15, wherein the instructions further cause the computer processor to:
receive a second price query for the current price of the content item, the second price query including the content item identifier;
identify, based on the content item identifier, the first updated content item account;
determine that none of the set of price calculation conditions have been met;
return the second monetary value in response to the second price query.

17. The non-transitory computer-readable medium of claim 15, wherein determining that the first price calculation condition of the set of price calculation conditions has been met comprises:
determining that a number of copies of the content item that have been sold meets or exceed a threshold number dictated by the first price calculation condition.

18. The non-transitory computer-readable medium of claim 15, wherein determining that the first price calculation of the set of price calculation conditions has been met comprises:
determining that a current time value meets or exceeds a threshold time value dictated by the first price calculation condition.

19. The non-transitory computer-readable medium of claim 15, wherein calculating the second monetary value comprises multiplying the first monetary value by a predetermined multiplier, yielding the second monetary value.

20. The non-transitory computer-readable medium of claim 15, wherein calculating the second monetary value comprises:
determining a velocity at which copies of the content item have been sold over a predetermined time period, wherein the second monetary value is calculated based on at least the velocity.

21. The non-transitory computer-readable medium of claim 15, wherein the instructions further cause the computer processor to:
receive a second price query for the current price of a content item, the second price query including the content item identifier identifying the content item;
identify the first updated content item account associated with the content item identifier;
determine, based on the set of price calculation rules, that a second price calculation condition of the set of price calculation conditions has been met;
calculate, based on at least a second algorithm of the set of algorithms, a third monetary value;
designate the third monetary value as the current price of the content item, yielding a second updated content item account; and
return the third monetary value in response to the second price query.
